(19) United States
(12) Patent Application Publication
(10) Pub. No.: US 2014/0359453 A1
(43) Pub. Date: Dec. 4, 2014

(54) Systems and Methods for Displaying Images on Electronic Picture Frames

(71) Applicant: Mark Palfreeman, London (GB)

(72) Inventor: Mark Palfreeman, London (GB)

(21) Appl. No.: 14/272,203

(22) Filed: May 7, 2014

Related U.S. Application Data
(60) Provisional application No. 61/831,120, filed on Jun. 4, 2013.

(51) Int. Cl. G06F 3/0484; H04L 29/08; G06F 17/30

(52) U.S. Cl. CPC G06F 3/04847; G06F 17/30244; H04L 67/06
USPC 715/731

(57) ABSTRACT

A computer-implemented method for displaying images comprises collecting a plurality images from one or more image repositories and generating, with the aid of a graphical user interface on an electronic display coupled to a server, a slideshow comprising images for display on an electronic picture frame. At least one image repository of the one or more image repositories can be a network accessible image repository. Next, the slideshow can be transmitted to the electronic picture. The slideshow can then be displayed on the electronic picture frame.

### CROSS-REFERENCE

This application claims priority to U.S. Provisional Patent Application Ser. No. 61/831,120, filed Jun. 4, 2013, which is entirely incorporated herein by reference.

### BACKGROUND

Picture frames provide a visually pleasing way to present photographs for display. Some prefer to use picture frames, rather than digital display mechanisms (e.g. computer monitors), because of the aesthetic qualities associated with such frames. However, several problems and disadvantages result from the use of traditional picture frames.

For example, a problem that may be encountered by picture frame users is that changing the picture in the frame requires a series of manual steps. For example, a person who wishes to change the picture must manually remove the picture and replace it with a new one. Consequently, changing the picture requires that a person be physically located at the same place where the picture frame resides.

An additional problem with picture frames is that a picture frame may not have the ability to adjust the dimensions and/or size of a given picture to fit within a display area of the frame. Pictures placed into the picture frame may need to correspond to the dimensions of the display area of the frame. This significantly limits pictures that may be displayed in the picture frame.

### SUMMARY

Recognized herein is the need for displaying content to end users with reduced or minimal effort by the end user in selecting content for display.

The present disclosure provides methods and systems for displaying media items (e.g., images, video) on electronic picture frames. An electronic picture frame can be located remotely with respect to a system that is programmed or otherwise configured to distribute media items for display on the electronic picture frame. The system can include a computer server (“server”). The electronic picture frame can be in communication with the server by direct connection (e.g., wired or wireless connection), or through a communication network, such as the Internet or an intranet.

The system can enable the picture frame to display media items in a manner (e.g., content, order of the content) selected by a user. For example, the user can select which images the user wishes to display and in which order. The system can also permit the user to select to, for example, randomize the order in which content is displayed.

The system can permit the user to generate a slideshow with content from one or more content repositories, such as social networking web sites. The user can display the slideshow on the electronic picture frame. In some examples, the user can display multiple slideshows on the electronic picture frame, or display media items from multiple slideshows for display on the electronic picture frame. The system can also permit the user to select an electronic picture frame to display content. For example, the user can select to display a first slideshow on a first electronic picture frame and a second slideshow on second electronic picture frame.

The present disclosure provides a startup slideshow that is a sequence of images that can display in a certain order on the electronic picture frame when the frame is turned on. It can be managed via an online application of the system, where the user can add photos to the slideshow and arrange their display order. The slideshow has multiple settings that allow the user to control the method in which the photos display. These settings include transitions (e.g., fade to next photo), delays, sorting order, photo scaling, orientation on the frame screen, and notification displays. These settings can be managed on the website as well as on the frame itself.

The system can provide the user the capability to have multiple slideshows, allowing the user to keep several selections of organized photos from which to choose from to display remotely on a digital photo frame or wireless device such as a tablet, Smartphone, e-reader or smart watch. The slideshow can mix one or more of text, photo, video and music files.

The electronic picture frame may be in communication with the system either directly (e.g., by wired or wireless connectivity), or through a network, such as the Internet or an intranet. In an example, the system is in communication with an electronic picture frame, and the user generates a slideshow by accessing the system remotely, such as through a web interface. The system may be accessed by an electronic device of the user, such as a personal computer (e.g., portable PC), slate or tablet PC (e.g., Apple® iPad, Samsung® Galaxy Tab), telephone, Smart phone (e.g., Apple® iPhone, Android-enabled device, Blackberry®), or personal digital assistant.

An aspect of the present disclosure provides a computer-implemented method for displaying images, comprising collecting, at a server programmed to collect images and generate slideshows from the images, a plurality images from one or more image repositories, wherein at least one image repository of the one or more image repositories is a network accessible image repository. Next, with the aid of a graphical user interface on an electronic display coupled to the server, a slideshow comprising images for display on an electronic picture frame is generated. The slideshow is then transmitted to the electronic picture frame that may be located remotely with respect to the server. The slideshow is then displayed on the electronic picture frame. In an embodiment, the network accessible image repository comprises a social network web site. In another embodiment, the network accessible image repository is accessible through a social network web site. In another embodiment, the electronic display is part of a mobile electronic device. In another embodiment, the slideshow show comprises an order of images that is selected by a user. In another embodiment, the slideshow show comprises an order of images that is selected by the server. In another embodiment, the slideshow show comprises an order of images that is selected by the electronic picture frame. In another embodiment, the plurality of images is collected from a plurality of image repositories. In another embodiment, the plurality of image repositories comprises a plurality of social network providers. In another embodiment, the plurality of images is automatically collected by the server without any user involvement. In another embodiment, the electronic picture frame is among a plurality of electronic picture frames that are in network communication with the server, and wherein each of the plurality of electronic picture frames is programmed to display the slideshow upon user request at the server. In another embodiment, the user interface is a web interface. In another embodiment, the plurality of images of the slideshow is from a first user, and the method further comprises displaying the slideshow on the electronic picture frame that is of (e.g., belongs to or is associated with) a second user.

Another aspect of the present disclosure provides machine-executable code that, upon execution by one or more computer processors, implements any of the methods above or elsewhere herein.

Another aspect of the present disclosure provides a system comprising a memory location that comprises machine-executable code implementing any of the methods above or elsewhere herein, and a computer processor in communication with the memory location. The computer processor can execute the machine executable code to implement any of the methods above or elsewhere herein.

Another aspect of the present disclosure provides a system for displaying images, comprising a server programmed to (i) collect a plurality images from one or more image repositories, wherein at least one image repository of the one or more image repositories is a network accessible image repository, and (ii) generate a slideshow from at least a subset of the plurality of images. The system further comprises an electronic picture frame that is located remotely with respect to and in network communication with the server. The electronic picture frame is programmed to (i) receive the slideshow from the server and (ii) display the slideshow. In an embodiment, the network accessible image repository comprises a social network web site. In another embodiment, the network accessible image repository is accessible through a social network web site. In another embodiment, the slideshow show comprises an order of images that is selected by a user. In another embodiment, the slideshow show comprises an order of images that is selected by the server. In another embodiment, the slideshow show comprises an order of images that is selected by the electronic picture frame. In another embodiment, the server is programmed to collect the plurality of images from a plurality of image repositories. In another embodiment, the plurality of image repositories comprises a plurality of social network providers. In another embodiment, the server is programmed to automatically collect the plurality of images without any user involvement.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the claimed invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” or “FIGS.” herein) of which:

FIG. 1 schematically illustrates a method for displaying media items, in accordance with various embodiments of the present disclosure;

FIGS. 2A and 2B schematically illustrate a graphical user interface (GUI) for generating slide shows, in accordance with various embodiments of the present disclosure;

FIGS. 3A-3C schematically illustrate an electronic picture frame sequentially displaying images from a slide show, in accordance with various embodiments of the present disclosure;

FIG. 4 schematically illustrates a system for facilitating methods of the disclosure; and

FIG. 5 shows a screenshot of graphical user interface (GUI) of a system for generating slideshows for display on electronic picture frames;

FIG. 6 shows another screenshot of a GUI of the system;

FIG. 7 shows another screenshot of a GUI of the system;

FIG. 8 shows another screenshot of a GUI of the system;

FIG. 9 shows another screenshot of a GUI of the system;

FIG. 10 shows another screenshot of a GUI of the system;

FIG. 11 shows another screenshot of a GUI of the system;

FIG. 12 shows another screenshot of a GUI of the system;

FIG. 13 shows another screenshot of a GUI of the system;

FIG. 14 is a screenshot of a GUI showing various albums.

FIG. 15 is a screenshot of a GUI showing various slideshows.

FIG. 16 is a screenshot of a GUI showing various electronic pictures frames that are configured for use with systems and methods of the present disclosure.

FIG. 17 is a screenshot of a GUI showing a settings page.

FIG. 18 is a screenshot of a GUI showing email albums.

FIG. 19 is a screenshot of a GUI showing Facebook® albums.

FIG. 20 is a screenshot of a GUI showing Picasa® albums

FIG. 21 is a screenshot of a GUI showing Instagram® albums;

FIG. 22 is a screenshot of a GUI showing various albums; and

FIG. 23 is a screenshot of a GUI in which a user is provided the opportunity to purchase storage space and various access plans.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “media item,” as used herein, generally refers to a textual, graphical, audio and/or video item. A media item can be provided by way of a text file, audio file, image file, or video file. An example of a media item is an image or video item. In some cases, a media item is an image, such as a static image or a dynamic image (e.g., animated GIF or Flash animation). Another example of a media item is text. A media item can be provided by way of an audio file (e.g., MP3 file). A media item can include or be associated with metadata.

The term “electronic picture frame,” as used herein, generally refers to an electronic display that is dedicated for the display of media items, such as images. An electronic picture frame can be a digital photo frame.

The term “slideshow” (also “slide show” herein), as used herein, generally refers to the collection of one or more media items, such as, for example, one or more images. A slide show can include images, the content and order of which may be selected in a manner determined by a user. The slide show can provide a user a snapshot of the layout, order and content of media items as would be presented on an electronic picture frame.

### Methods

An aspect of the present disclosure provides a method for displaying images, comprising collecting a plurality images from one or more image repositories. The images can be collected by a computer server programmed to collect images and generate slideshows from the images. At least one image repository of the one or more image repositories can be a network accessible image repository. Next, with the aid of a user interface on an electronic display coupled to the server, a slideshow comprising images can be generated for display on an electronic picture frame. The user interface can be a graphical user interface. Next, the slideshow can be transmitted to the electronic picture frame. The electronic picture frame can be located remotely with respect to the server but in communication with the server through, for example, a network. The slideshow can then be displayed on the electronic picture frame.

In some cases, the network accessible image repository comprises a social networking web site (or social networking provider), such as, e.g., Facebook®, Foursquare®, Google+®, Linkedin®, Pinterest®, or Tumblr®. The network accessible image repository can be a data storage unit that is in communication with the server through a network or by direct (e.g., wired or wireless) connectivity.

A user can select images for display on the electronic picture frame. The content of the slide show (e.g., images, order of images) can be selected by the user. The user can generate the slide show by manipulating images on the user interface. In some examples, the user can drag and drop images from a module representing an image repository of the server to a module representing the slide show.

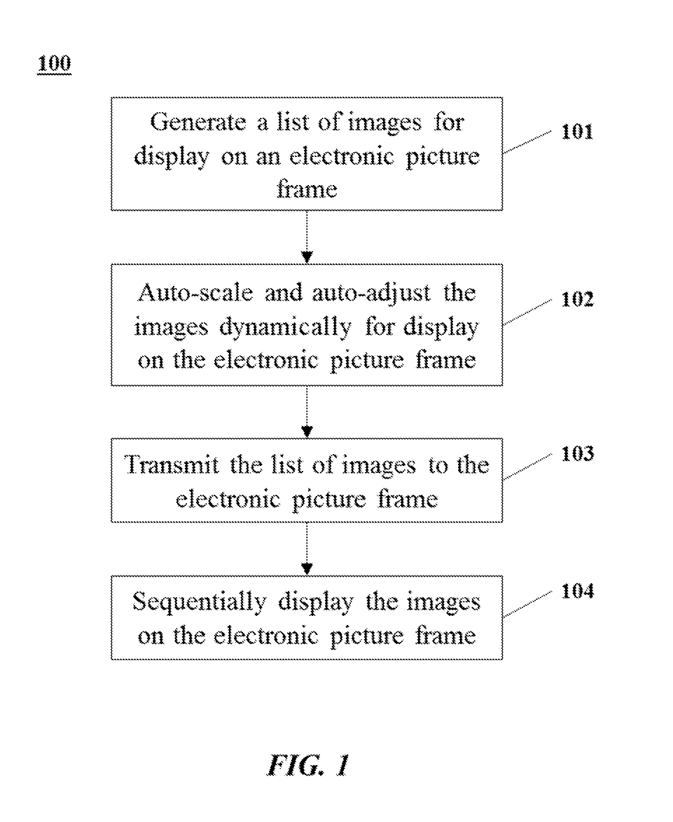

FIG. 1 schematically illustrates a method 100 for displaying media items. The media items in the illustrated example are images, but other media items (e.g., text or video items) may be used. In a first operation 101, the method 100 comprises generating a list of images for display on an electronic picture frame. The list can be generated using a user interface displayed on an electronic display coupled to a server programmed to collect and generate slide shows. Next, in a second operation 102, the images can be resized dynamically by the system to get the best possible format for the electronic picture frame. The images can be auto-scaled and auto-adjusted while maintaining an original copy for future use on a different sized electronic picture frame.

In a third operation 103, the list of images is transmitted to the electronic picture frame. The images in the list can be transmitted to the electronic picture frame in their entirety, or individual images in the list can be transmitted to the electronic picture frame sequentially (i.e., one after another) or in pseudo-random order. In some example, the electronic picture frame includes a memory location (e.g., flash memory, hard disk) for storing images for display on the electronic picture frame.

In the fourth operation 104, the images from the slide show are sequentially displayed on the electronic picture frame. As an alternative, the order of the images can be randomized, and the images can be displayed in random (or pseudo-random) fashion. In some instances, prior to the fourth operation 104, a list of resized images can be generated for display on the electronic picture frame.

In some cases, a slideshow is a sequence of images that may display in a certain order on an electronic picture frame when the frame is turned on. It can be managed via a network accessible (e.g., online) application that can enable a user to add media items (e.g., photographs) to the slide show and arrange the display and order of the media items.

The slideshow can have multiple settings that allow the user to control the method in which the media items display. These settings include transitions, delays, sorting order, media item (e.g., photograph) scaling, orientation on the frame screen, and notification displays. These settings can be managed by accessing the server (e.g., through network access) or, alternatively or in addition to, on the electronic picture frame.

A user may have multiple slide shows allowing the user to keep several selections of organized media items from which to choose from to display remotely on an electronic picture frame or wireless device, such as a tablet PC, Smartphone, e-reader or smart watch.

### Slideshows

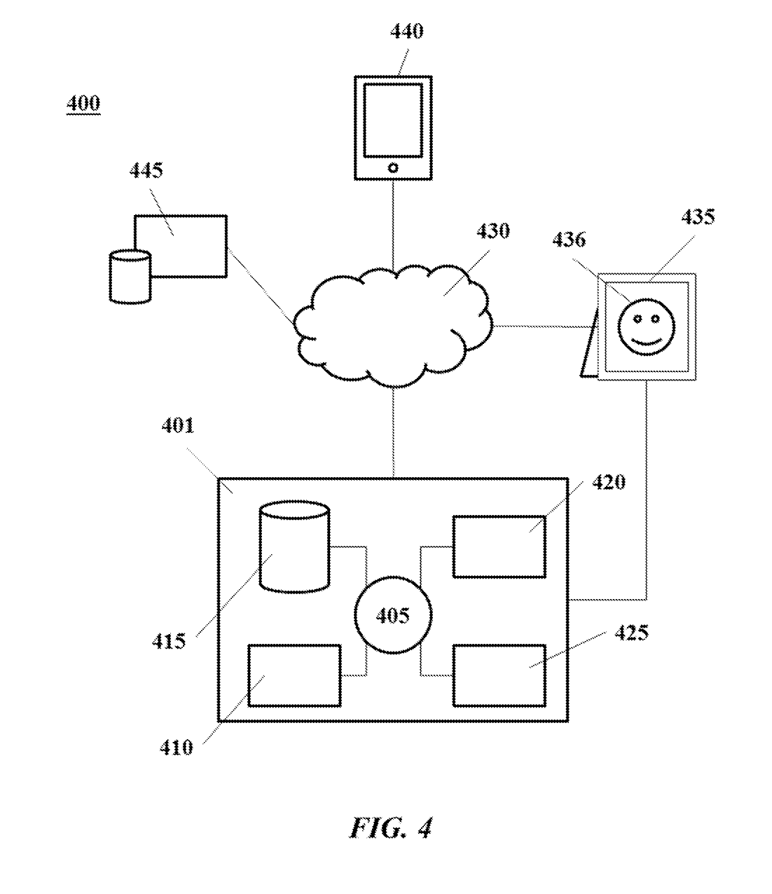

Another aspect of the present disclosure provides slideshows for display on an electronic picture frame. The slideshow can be generated with the aid of a computer system that is programmed to generate slideshows, such as the server 401 of FIG. 4. The computer system can have multiple user accounts, with each user account dedicated to a user. Each user account can be configured to permit a user to distribute media items (e.g., through slideshows) to one or more electronic picture frames.

A slideshow can be generated with the aid of a user interface that includes one or more media items that can be included in the slideshow. The user interface can be a graphical user interface, which can be presented to a user on an electronic device of the user. The user can generate, revise and/or update a slideshow with the aid of the user interface.

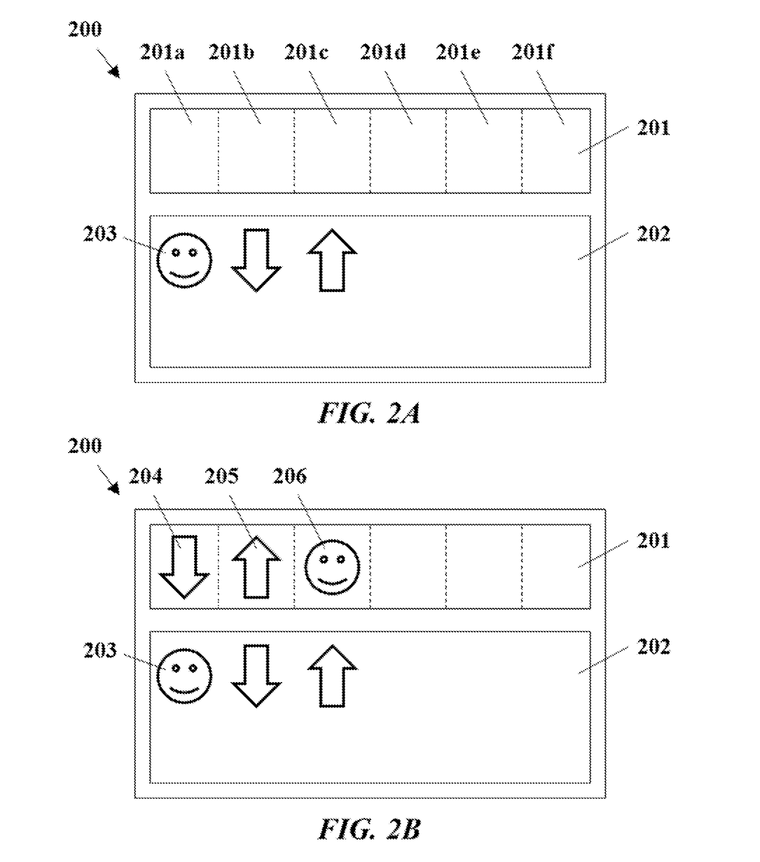

FIG. 2A shows a user interface 200 that includes a slideshow area 201 and a media item area 202. The interface 200 can be dedicated to an account of a given user. Multiple users can each have their own accounts.

The media item area 202 includes a media item 203 that can be included in the slideshow area 201. One or more media items can be taken from the media item area 202 into the slideshow area 201, for example, by dragging and dropping media items from the media item area 202 into the slideshow area 201. The media items in the illustrated example are images. With reference to FIG. 2B, media items from the media item area 202 have been included in the slideshow area 201. The media item 203 appears in the slideshow area 201 as a media item 204 ready for display in an electronic picture frame. Media items included in the slideshow area 201 can be directed to an electronic picture frame for display to a user.

The slideshow area 201 includes individual cells 201a, 201b, 201c, 201d, 201e and 201f that display media items that can be displayed in an electronic picture frame. In the slideshow area 201, a user can select the order in which content is displayed in the electronic picture frame.

In the illustrated example, a first media item 204, second media item 205 and third media item 206 have been included from the media item area 202 into the slideshow area 201. The third media item 206 corresponds to the media item 203 in the media item area 202. The slideshow area 201 can be used to generate a slideshow, which can be displayed on an electronic picture frame. The first media item 204, second media item 205 and third media item 206 can be display on the electronic picture frame in sequence—i.e., the first media item 204 can be displayed first, the second media item 205 can be displayed after the first media item 204, the third media item 206 can be displayed after the second media item 205, and so on. After the last media item has been displayed, the slide show may, in some cases, loop back to the first media item.

Media items provided in a slideshow may be displayed in an electronic picture frame in an order selected by the user (e.g., the order set in the slideshow) or in random (or pseudo random order). The user may elect to have the server or electronic picture frame shuffle media items and display the media items on the electronic picture frame in an order that can be dictated by the shuffle. While media items are displayed in an electronic picture frame, the user may select to manually view other media items, skip certain media items, or transition to other media items.

In some cases, the slideshow area 201 can be used to generate a slideshow as a single file that includes the media items. The single file can be directed to the electronic picture frame, and the media items from the single file can be displayed on the electronic picture frame. As an alternative, individual media items from the slideshow area 201 can be directed to the electronic picture frame individually for display on the electronic picture frame.

In the illustrated example of FIGS. 2A and 2B, the slideshow area 201 includes six cells, but the slideshow area 201 can include any number of cells. The slideshow area 201 can include at least 1, 2, 3, 4, 5, 6, 7, 8, 9, 10, 20, 30, 40, 50, 60, 70, 80, 90, 100, 200, 300, 400, 500, 1000, 10,000, or 50,000 cells. Each cell can accommodate at least one media item (e.g., image), or multiple media items. A given cell can accommodate at least 1, 2, 3, 4, 5, 6, 7, 8, 9, 10, 30, 40, or 50 media items.

A slideshow can be used to generate a slideshow stream for display on an electronic picture frame. The slideshow stream can be used to provide media items of a single type to the electronic picture frame, or multiple types of media items. For example, a user may wish to provide images for display on an electronic picture frame, and have each or all of images displayed with a given sound (e.g., music, voice recording). In an example, an entire slideshow is coupled with a given soundtrack. In another example, individual images in a slideshow are coupled with music or voice recordings (e.g., voice information provided to accompany an individual image). A slideshow generated for display on an electronic picture frame can include multiple types of media items, such as, for example, images and sound, images and text, sound and text, video and text, or images, sound and text.

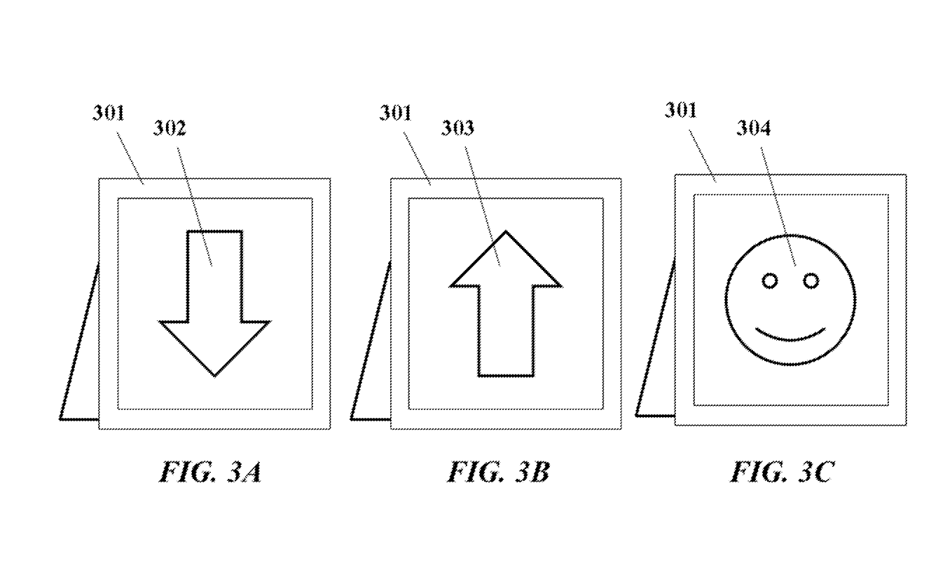

FIGS. 3A-3C shows media items sequentially displayed on an electronic picture frame 301. The media items in the illustrated example are images. The images correspond to those in the slideshow area 201 of FIG. 2B. In FIG. 3A, at a first time, a first media item 302 is displayed on the electronic picture frame 301. In FIG. 3B, at a second time after the first time, a second media item 303 is displayed on the electronic picture frame 301. In FIG. 3C, at a third time after the second time, a third media item 304 is displayed on the electronic picture frame 301.

Media items can be displayed on electronic picture frame at a rate (i.e., media items per unit time) that may be selected by a computer system automating the display of media items, or selected by a user. In some embodiments, media items are displayed to a user at a rate of 1 media in a time period of at least about 1 second, 2 seconds, 3 seconds, 4 seconds, 5 seconds, 10 seconds, 30 seconds, 1 minute, 2 minutes, 3 minutes, 4 minutes, 5 minutes, 10 minutes, 20 minutes, 30 minutes 1 hour, 2 hours, 3 hours, 4 hours, 5 hours, 6 hours, 12 hours, or 1 day. The order of media items can be preselected by the computer system, or selected by the user (e.g., with the aid of a slideshow in a user interface, see above).

The present disclosure provides methods for distributing slideshows on various electronic picture frames. A user can create one or more slideshows with the same or different media items (e.g., “My holiday” slideshow, “My pictures of spaceships” slideshow). A given slideshow can be forwarded to electronic picture frames owned by the user or one or more other users. For example, a “Holiday” slideshow can be generated by a first user and transmitted to an electronic picture frame of a second user. The second user can be located in a different location than the first user.

In some cases, a user can program or otherwise configure an electronic picture frame to automatically display slideshows at a given day and/or time, such as different times of the day, different days of the week, different weeks of the month, or different months of the year. The user can set the frequency at which a slideshow is displayed on a given electronic picture frame.

Multiple electronic picture frame can be linked to a given user account. Different slideshows can be played on different frames on a single account. In some cases, multiple users, through multiple accounts, can distribute media items to a single electronic picture frame.

### Systems

Another aspect of the disclosure provides a system that is programmed or otherwise configured to implement the methods of the disclosure. The system can include a computer server that is operatively coupled to electronic picture frame. The computer server can generate media items for display on the electronic picture frame.

FIG. 4 shows a system 400 programmed or otherwise configured to enable a user to generate media items for display on a electronic picture frame, in accordance with various embodiments of the present disclosure. The system 400 includes a computer server (“server”) 401 that is programmed to implement methods disclosed herein. The server 401 includes a central processing unit (CPU, also “processor” and “computer processor” herein) 405, which can be a single core or multi core processor, or a plurality of processors for parallel processing. The server 401 also includes memory 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The server 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the server 401, can implement a peer-to-peer network, which may enable devices coupled to the server 401 to behave as a client or a server.

The storage unit 415 can be a repository for media items. The storage unit 415 can store files, such as files related to media items that may be displayed on a electronic picture frame. Examples of files include sound, image, and video files. The storage unit 415 can store user data, e.g., user preferences and media items. The server 401 in some cases can include one or more additional data storage units that are external to the server 401, such as located on a remote server that is in communication with the server 401 through an intranet or the Internet.

The server 401 can communicate with one or more remote computer systems through the network 430. In the illustrated example, the server 401 is in communication with an electronic picture frame 435 displaying a media item 436, a first computer system 440 and a second computer system 445 that are located remotely with respect to the server 401. The first computer system 440 can be the computer system of the user, and the second computer system 445 can be the computer system of a media item repository or source, such as, for example, a social network web site, cloud storage, or other data repository. The first computer system 440 can be, for example, personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants.

The server 401 can collect or aggregate media items from various repositories or data storage locations, such as network repositories, email and physical data storage locations. Examples of physical data storage locations include, without limitation, flash memory, hard disks and universal serial bus (USB) drives. Physical storage locations can be external to the server 401. The server 401 can include one or more ports for coupling to physical storage locations.

The electronic picture frame 435 displays the media item 436 (e.g., one or more images) prepared by the server 401. The electronic picture frame 435 can be coupled to the server directly or through the network 430. The electronic picture frame 435 can be attached to the server by physical (e.g., wired connectivity), or through wireless connectivity.

In some situations, the system 400 includes a single server 401. In other situations, the system 400 includes multiple servers in communication with one another through an intranet and/or the Internet.

The server 401 can be adapted to store user profile information, such as, for example, a name, physical address, email address, telephone number, instant messaging (IM) handle, educational information, work information, social likes and/or dislikes and historical information. Such profile information can be stored on the storage unit 415 of the server 401.

Methods as described herein can be implemented by way of machine (or computer processor) executable code (or software) stored on an electronic storage location of the server 401, such as, for example, on the memory 410 or electronic storage unit 415. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410. Alternatively, the code can be executed on the second computer system 440.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the server 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The server 401 can be configured for data mining, extract, transform and load (ETL), or spidering (including Web Spidering where the system retrieves data from remote systems over a network and access an Application Programming Interface or parses the resulting markup) operations, which may permit the system to load information from a raw data source (or mined data) into a data warehouse. The data warehouse may be configured for use with a business intelligence system (e.g., Microstrategy®, Business Objects®). The system can include a data mining module adapted to search for media items in various source locations, such as email accounts and various network sources, such as social networking accounts (e.g., Facebook®, Foursquare®, Google+®, Linkedin®) or on publisher sites, such as, for example, weblogs.

The server 401 can be configured to access and aggregate data from various network sources, such as social media sources. For instance, the server 401 can access a social media account of a user and aggregate media items or collections (e.g., albums) of media items. The server 401 can also access an electronic mail (email) account of the user and aggregate (or collect) media items. Media items aggregated by the system can be stored in the electronic storage unit 415 of the server 401. As an alternative, the server may aggregate links to media items on various network accessible repositories (e.g., social media web sites), and upon the user generating a slideshow, the user may download a given media item from the repository and store the given media item in the electronic storage unit 415.

Media items can be presented to a user on a user interface (UI) of an electronic device of the user. The user may select a media item for display on the electronic picture frame 435. Examples of UP's include, without limitation, a graphical user interface (GUI) and web-based user interface. A GUI can enable a user to access a repository of media items or a slide show. The GUI can enable the user to edit a slideshow, such as upload items to the slideshow for display on the electronic picture frame 435. The UI (e.g., GUI) can be provided on a display of an electronic device of the user. The display can be a capacitive or resistive touch display, or a head-mountable display (e.g., Google® Glasses). Such displays can be used with other systems and methods of the disclosure.

Methods of the disclosure can be facilitated with the aid of applications (apps) that can be installed on electronic devices of a user. An app can include a GUI on a display of the electronic device of the user. The app can be programmed or otherwise configured to perform various functions of the system.

The electronic picture frame 435 can include an electronic display for displaying media items (e.g., images) to a user. The electronic picture frame 435 can include a computer processor programmed or otherwise configured to generate images for display to the user. The computer processor can be a graphics processor. The electronic picture frame can include memory (e.g., flash memory, hard disk) for storing media items, and a communication interface for communication with the server 401. The communication interface can be a wired and/or wireless interface. The electronic picture frame 435 can include a passive display, or a touch screen, such as a capacitive or resistive touch screen. The electronic picture frame 435 can include speakers for broadcasting sound (e.g., music), and a microphone for receiving user input.

In some examples, the electronic picture frame 435 is an electronic display that is dedicated for displaying slideshows generated by the server 401. As an alternative, the electronic picture frame 435 can be a personal computer (e.g., portable PC), slate or tablet PC (e.g., Apple® iPad, Samsung® Galaxy Tab), telephone, Smart phone (e.g., Apple® iPhone, Android-enabled device, Blackberry®), or personal digital assistant.

The electronic picture frame 435 can have various sensors, such as a motion sensor for detecting motion in front of or in proximity to the electronic picture frame 435, or environmental sensors, such as a pressure sensor, light sensor, humidity sensor, or temperature sensor. The electronic picture frame 435 can include a gyroscope for detecting the orientation of the electronic picture frame 435, and/or an accelerometer for detecting motion of the electronic picture frame 435.

The electronic picture frame 435 can display notifications to alert the user of various events, such as receiving a new email or losing connection. Alerts that display while a slideshow is playing can display the icon of the particular event, for example, in the top right hand corner of the frame screen. The user can dismiss the alert. Once an alert is dismissed, the alert may not show again until the state of that alert has changed (e.g., a new email is received, the connection to the server is gained and then lost).

In some examples, an electronic picture frame has motion sensors. From an account of the user on the system, the user can remotely determine if there is movement in any room or area in which the electronic picture frame is situated. The user can access the account on an app installed on an electronic device of the user, such as a personal computer (e.g., portable PC), slate or tablet PC (e.g., Apple® iPad, Samsung® Galaxy Tab), telephone, Smart phone (e.g., Apple® iPhone, Android-enabled device, Blackberry®), or personal digital assistant. The app can automatically alert the user if any movement has been detected by the sensor, or permit the user to manually determine if any movement has been detected by the sensor.

Systems of the present disclosure can enable a user to view and generate slideshows on mobile devices (e.g., Smartphone, laptop, tablet PC) of the user. A mobile device can include an app with a user interface, such as a graphical user interface, that allows the user to view media items from various repositories, generate slideshows and distribute the media items (e.g., via slideshows) to one or more electronic picture frames. The app can permit the user to create slideshows in either an online mode, in which the mobile device is connected to the server 401, or an offline mode, in which the mobile device is not connected to the server 401 but may later synchronize with the server 401. A slideshow created on the mobile device can be directed to the server 401 (e.g., pushed to the server) for storage and subsequent use, it can be sent to an electronic picture frame either through the server 401 or directly from the mobile device to the electronic picture frame, or it can be sent to an electronic picture frame of another user.

### Marketplace

Systems of the present disclosure can provide a marketplace for users to create slideshows to for sale or distribution to other users. For example, an independent photographer can upload a themed collection of photos and allow a user with an account on the server 401 to pay a fee and the slideshow will then appear on a designated electronic picture frame of the user.

The marketplace can allow third parties to offer collections of media items (e.g., photographs) that users may be interested in subscribing to. A user can subscribe to collections of media items on a paid or non-paid basis.

In an example, Company releases a new camera that takes photographs. Company uploads to the marketplace a collection of photographs taken with the camera by a famous photographer. The collection of photographs can be uploaded in the form of individual media items or a slideshow.

The system can offer the collection to a user for free or for a fee (e.g., monthly or yearly subscription fee). The collection can be added to the user's account in the form of a slideshow, which can be added to the user's collection of slideshows. The user can select a collection and request that the system transmit the collection as a slideshow to an electronic picture frame for display.

In some cases, if the collection is provided by a third party, the system can automatically add a brand logo or message of the third party to an individual media item that is included in the collection. This may be applicable in instances in which a user is using the system for commercial digital advertising.

In some examples, a user can have a given (e.g., selected, user determined) preference for certain interests. In an example, a user likes computer games. On the marketplace a computer game company offers subscriptions for slideshows featuring images from the latest game releases. The user subscribes and once a month the computer game company uploads a new slideshow with new images (e.g., screenshots) from their new games. The system can watermark the images automatically with the computer game company's logo. The slideshow can then be added to the user's collection of slideshows. The slideshow can then be transmitted (e.g., pushed) by the system to an electronic picture frame of the user.

### Linked Media Items

Systems of the present disclosure can be programmed or otherwise configured to operate with media items of relatively large data sizes (e.g., high definition video that streams at a rate of about 2.2 GB per 10 minutes of footage). A user can upload a media item (e.g., video) to a media item storage system (e.g., third party media item storage system, such as, for example, Youtube®). The user can then provide the media item as a link in a slide show of the user. For instance, in the media item area 202 of the user interface 200, the system can provide the user with a link to the media item. The link can include a universal resource locator (URL) of the media item. The user can include the link in the slideshow area 201. The system can then transmit the slideshow to an electronic picture frame. Upon accessing the linked media item, the electronic picture frame can follow the link (e.g., access the URL) and display the linked media item. In some examples, the electronic picture frame streams the linked media item (e.g., streams video). For example, the electronic picture frame can stream a Youtube® video.

The user interface can provide the user with a data entry filed to input a URL or other system or network path to a media item. The user interface can then include an icon representative of the linked media item. The icon can have a field to enable the user to input a name or description of the icon. The icon can be dragged and dropped into a slideshow. The icon can be moved and manipulated in the same way as any media item (e.g., photograph) in the slideshow. Linking media items can enable the user and the system to save in storage costs and fees, and provide system bandwidth that can be used to store other media items.

### Notifications

In another aspect of the present disclosure, a system programmed or otherwise configured to provide slideshows provides one or more notifications to a user. A notification can be presented on an electronic picture frame of a user. Examples of notifications include on-screen messages, graphics and/or sound.

Notifications can be provided in response to various events. Notifications can be presented by way of icons on an electronic display of the electronic picture frame.

A notification can be presented in response to a given event, such as a system-level event (e.g., transmitting a new slideshow) or an event at the electronic picture frame (e.g., message received by the electronic picture frame, electronic picture frame battery is low).

In an example, the electronic picture frame can provide the user a notification if connectivity to the system has been lost (e.g., lost WiFi connection). As another example, the electronic picture frame can present the user with a notification if an electronic communication, such as an electronic mail (email), has been received by the system and forwarded to the electronic picture frame, or received directly by the electronic picture frame. The electronic communication can include a media item. As another example, a notification can be provided to the user if the electronic picture frame is busy downloading new media items (e.g., images).

In some cases, the electronic picture frame can include translucent materials with one or more light emitting diodes (LED). Each LED can be individually controlled. An LED can be controlled by the system or the electronic picture frame, such as by an operating system of the electronic picture frame. Each LED or a group of LED's can notify the user of critical information using lights. This can be used as an alternative or in addition to on-screen messages.

LED's can be provided in the vicinity of an electronic display of the electronic picture frame. For instance, LED's can be provided at a given location (e.g., corner) of the electronic picture frame, or generally surrounding the electronic display.

LED's can be used to generate a lightshow in response to a system or electronic picture frame-level event. In an example, if the electronic picture frame loses connectivity to the system (e.g., if network connectivity is lost), the electronic picture frame can pulsate to notify the user. In another example, if the electronic picture frame is updating, the electronic picture frame can perform a lightshow to let the user know that an update is in progress. In another example, the electronic picture frame can perform a lightshow if the user has received an electronic message. The electronic message can include a media item.

The user can tailor a given lightshow to a given system or electronic picture frame-level event using the settings of the system. The settings can be accessed through a user interface of the system, as described elsewhere herein.

A lightshow can include turning one or more LED's on or off, such as per a given sequence. A user can associate a given system or electronic picture frame-level event with a given lightshow. The user can assign a lightshow and color schemes to different friends.

### Networked Frames for Home and Commercial Use

Another aspect of the present disclosure provides networked electronic picture frames. Electronic picture frames can be networked on a single user account. A user can use systems of the present disclosure to select a slideshow for display on a given electronic picture frame.

Each frame in a separate room or area can be associated with an assigned designation (e.g., “Master Bedroom” or “Kitchen”). The designation can be assigned using the settings of the system, which can be accessed through a user interface of the system, as described elsewhere herein.

A slideshow can be selected for display on a given electronic picture frame. The user can choose different slideshows for assigned frames. For example, the user can select a first slideshow for display on an electronic picture frame in a first bedroom, a second slideshow for display on an electronic picture frame in a second bedroom, and a third slideshow for display in the living room. This may be applicable in instances in which a user is using the system for commercial use or personal use.

Another aspect of the present disclosure provides managing of multiple frames from one account. The media can be sent to one or multiple frames at the same time, as chosen in the settings; this can be implemented through the same or unique email address as the web platform login.

Sending media to single or multiple frames can also be achieved by slideshows comprising media from different locations including, but not limited to albums (e.g., user-created albums), email, and/or one or more social network providers (e.g., Facebook®, Myspace®, Tumblr®, Pinterest®, Google+®, Instagram®, Twitter®, Yelp®, Linkedin®, or Foursquare®).

### Example 1

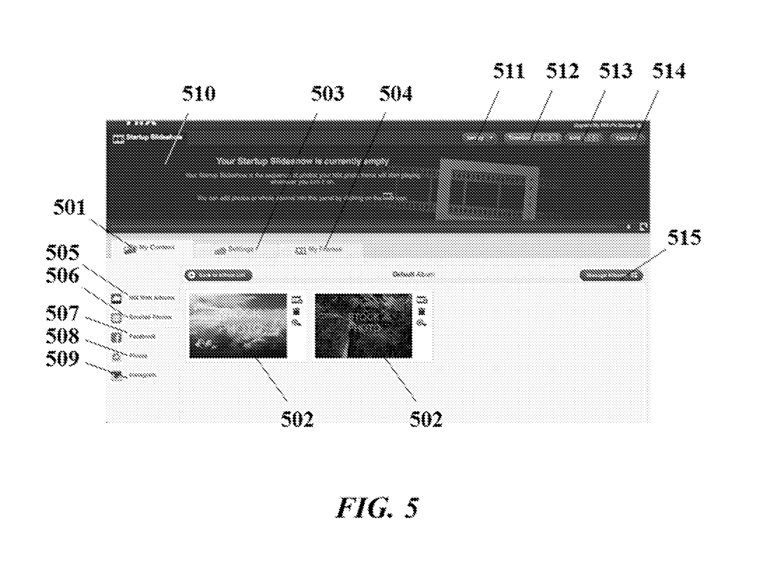

FIG. 5 is a screenshot of a graphical user interface (GUI) of a system for generating slide shows for display on an electronic picture frame. The system can be the server 401 of FIG. 4. The GUI can be used to generate slideshows for display on an electronic picture frame. The GUI can be accessed by a user.

The GUI of FIG. 5 comprises a content tab 501 with a media item area that includes media items 502 (photographs in the illustrated example), a settings tab 503 and a frames tab 504 that provides the user access to electronic picture frame that may be coupled to the system. Under the content tab 501, links to various repositories or sources of media items are provided, including a link to World Wide Web albums 505, a link to media items received by electronic mail (email) 506, a link to Facebook® 507, a link to Picasa® 508 and a link to Instagram® 509. The Facebook link 507 enables the user to retrieve media items from a Facebook account of the user. Links to other repositories, including social media web sites, may be included in the content tab 501. Links to repositories can include social media websites or other websites that include media items, such as, e.g., Facebook®, Myspace®, Tumblr®, Pinterest®, Google+®, Instagram®, Twitter®, Yelp®, Linkedin®, or Foursquare®.

The GUI can further comprise a slideshow area 510 that displays media items from the content tab 501. The user can select media items to include in a given slideshow in the slideshow area 510, and sort the order of the media items for display on an electronic picture frame. The user can select a sort link button 511 to sort media items in a given slideshow, such as newest to oldest media items, oldest to newest media items, alphabetical order, randomly, or by location. Selecting random from the sorting drop-down can shuffle the images randomly. Each time random sorting is selected, the media items may be reshuffled. Selecting alphabetical sorting can sort the images via filename, in ascending or descending order. Selecting new/old sorting can sort the media items based on the date the media items were taken as per their date/time metadata (e.g., timestamp). Media items without chronological metadata can use the current date when imported (or aggregated). Under location sorting, data tagged to the media item by the capture device (e.g., camera, Smartphone) can be used to sort media items by location.

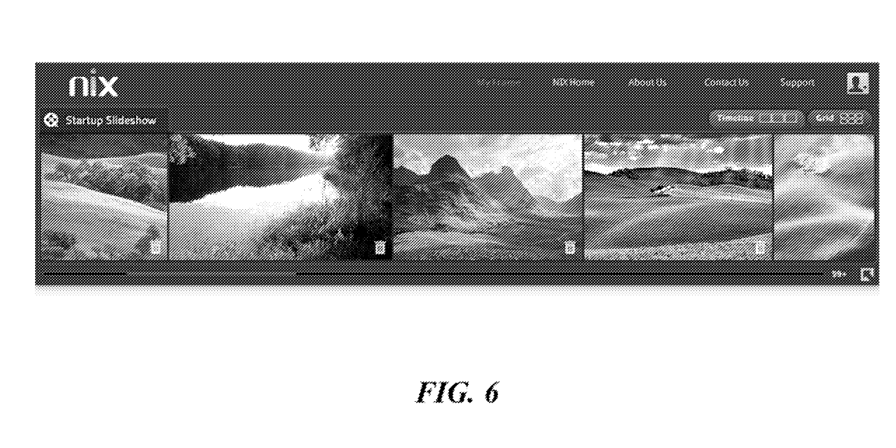

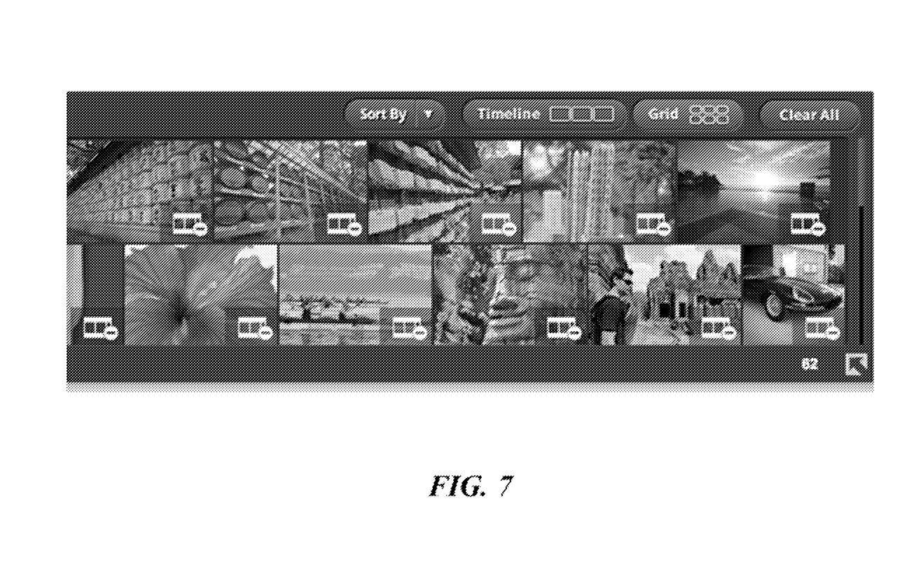

The user can choose a timeline button 512 to display media items in a timeline, or a grid button 513 to show the media items in a grid. FIG. 6 is a GUI showing media items displayed in a timeline, and FIG. 7 is a GUI showing media items displayed in a grid. In timeline view, all media items in the slideshow will appear as a single line. A horizontal scroll bar can be displayed in timeline view to enable the user to scroll to view other media items. In grid view, all media items in the slideshow will display smaller, in several rows and columns. A vertical scroll bar can be shown when in grid view to enable the user to scroll to view other media items.

In a given slideshow, a user may add media items, remove media items, or change the order in which media items are displayed on an electronic picture frame. The user may edit a given media item, such as changing the size, orientation, shape, color, brightness, saturation, or other characteristic of the media item. The user may select the rate at which media items are displayed on the electronic picture frame, and select the rate and manner in which a displayed media items fades out and a new media item fades in. The user may select effects associated with transitions from one media item to another when media items are displayed on an electronic picture frame.

With reference to FIG. 5, the GUI includes a clear all button 514 that removes media items from the slideshow shown in the slideshow area 510. The user may select the clear all button 514 and clear a given slideshow, and proceed to populate the slideshow with new media items from the content tab 510.

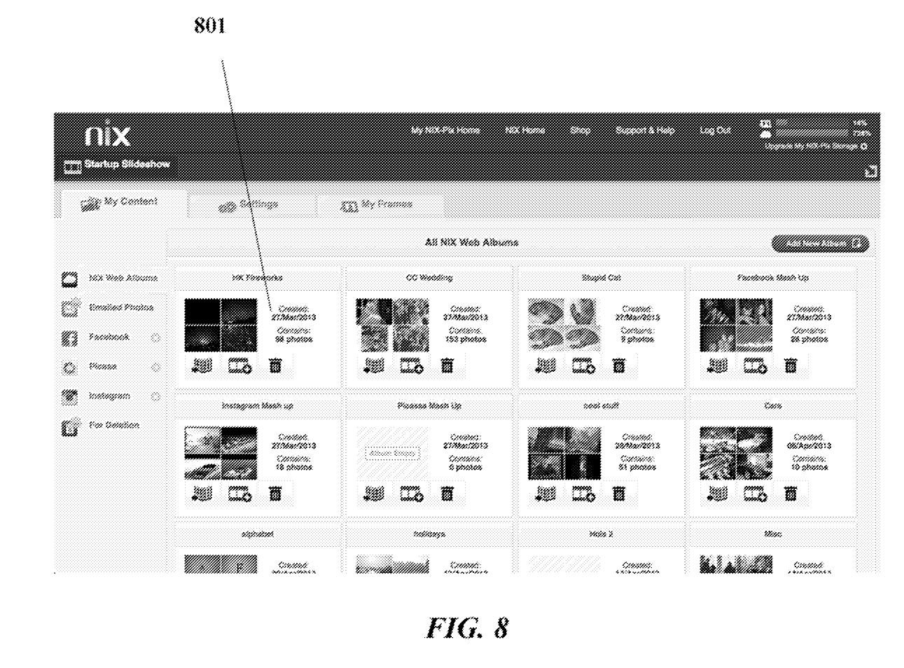

The GUI of FIG. 5 further includes a manage albums button 515 that enables the user to create new albums. This enables the user to have multiple albums, such as, for example, a “Family Album” and a “Friends Album.” Each album can include media items that can be used to generate a slideshow in the slideshow area 510. A user can elect to generate a slide show using all or a subset of media items in a given album. FIG. 8 shows a GUI with multiple albums 801, each including a collection of media items (photographs in the illustrated example). From a given album, the user can elect to delete the album, add the entire album to the slideshow, or view the album to select media items to include in the slideshow.

Media items, including albums, may be aggregated (or collected) from media items from the links 505-509. For example, when the user selects the Facebook link 507, the user's Facebook albums containing photographs (also “photos” herein) may be shown. As an alternative, or in addition to, media items, including albums, may be aggregated from other sources, such as electronic mail (email). A media item may be aggregated by downloading the media item to the system or by recording a link to an external repository of the media item.

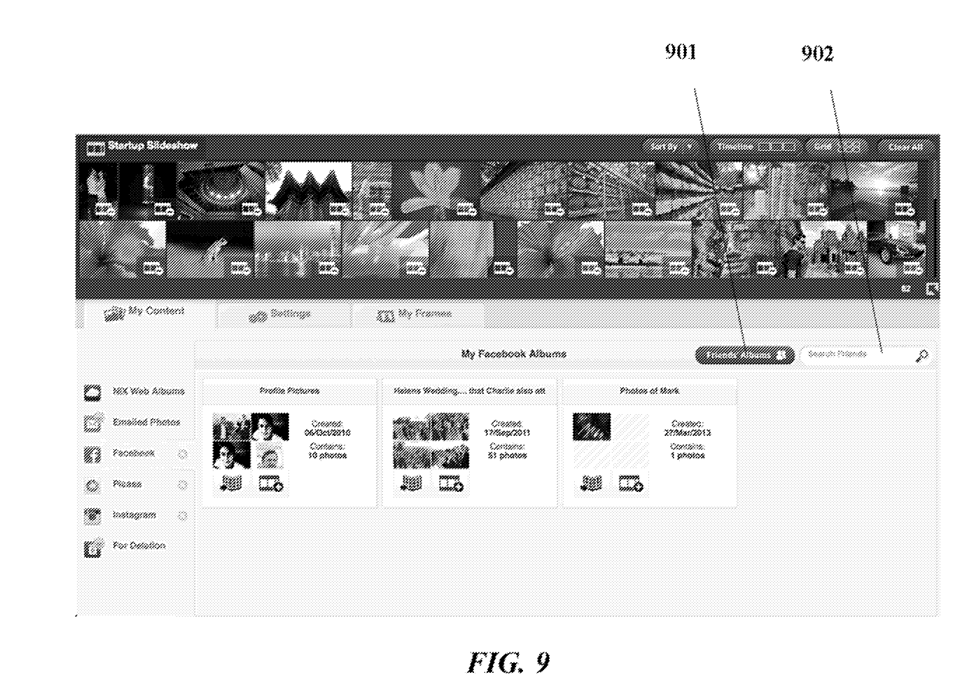

The Facebook link 507 enables the user to view the user's albums as well as albums of the user's friends on Facebook. With reference to FIG. 9, a friends' albums button 901 shows albums of the user's friends, with each album containing media items (e.g., photographs). A search box 902 enables the user to search for media items at the links 505-509.

The system can access each of the links 505-509 and display albums that the system detects at and display albums that the system detects at the repositories, or the system can access the repositories at the links 505-509 and aggregate media items into albums.

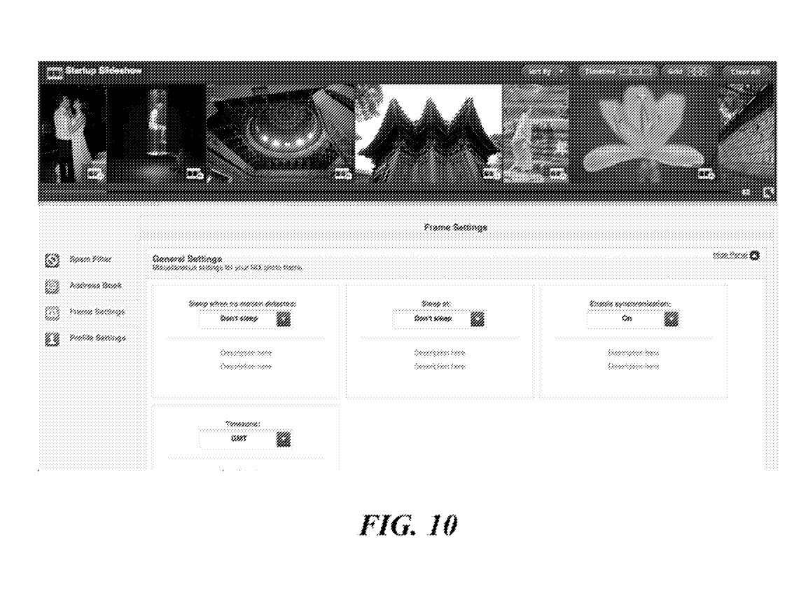

Under the settings tab 503, the user can access frame settings, as shown in FIG. 10. The frame settings can include general settings and slideshow settings. Frame settings include settings that may relate to an electronic picture frame, such as setting the electronic picture frame to sleep when, e.g., no motion is detected or subsequent to a given time period (e.g., 30 minutes, 1 hour, 3 hours) upon initiating the display of media items on an electronic picture frame. The frame settings can further enable synchronization, and setting the time zone of the frame. With synchronization, when a media item (e.g., an album, photo) is added or updated on the server, when the electronic picture frame polls the server for changes, it can be notified that there are changes and the synchronization process can synchronize the media items on the server with the media items on the electronic picture frame.

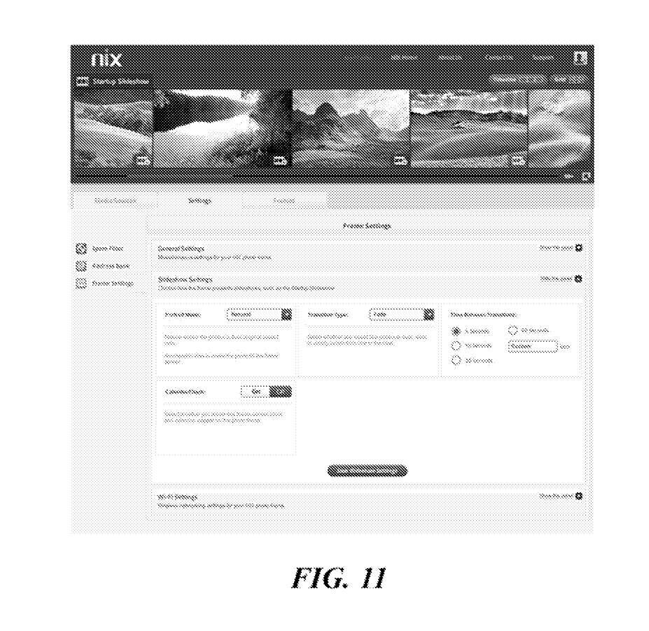

FIG. 11 shows a GUI with slideshow settings. Under slideshow settings, the GUI enables the user to select a portrait mode, transition type, time between transitions and calendar/clock. Under transitions, when switching between media items in a slideshow there may be a transition effect (e.g., Ken Burns, fade to next). The user can select a transition effect to apply to a slideshow from a drop-down menu.

The user can select photo fitting options in which the user can select to have the photos either fill the screen or fit to screen. Fitting the screen can display the entire image scaled to fit in the boundaries of the frame screen, displaying borders outside the image if the aspect ratio is not exact to the screen. Fill screen can display the image without borders and will crop any parts of the image that exceed the size of the screen, fill screen will cause images to pan through the areas outside the frame screen.

The user can select from various image intervals. The user can set how long each media item will be displayed by setting the interval, such as, for example, at 10 second, 30 second, 40 second, 1 minute, 2 minute, 5 minute, or 10 minute intervals.

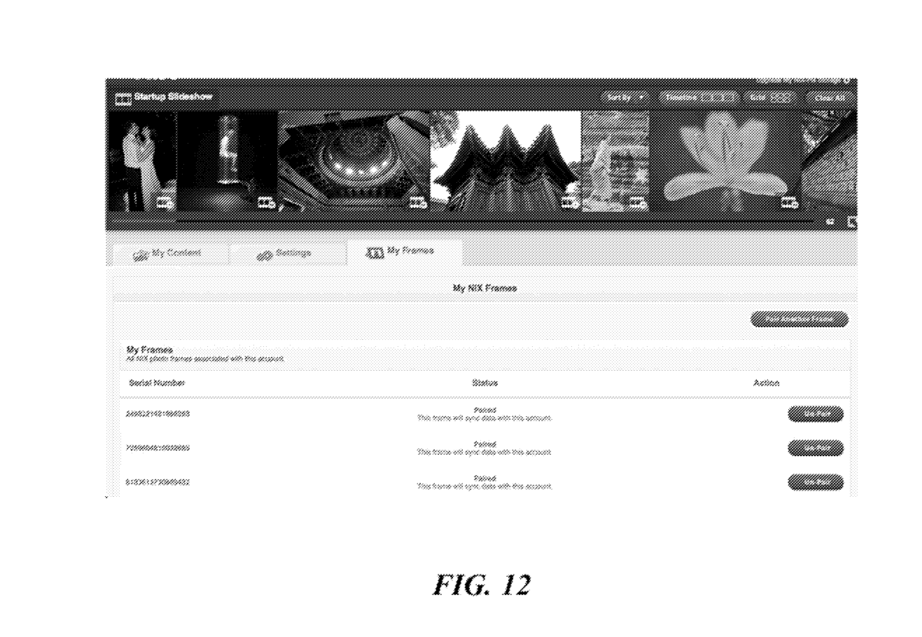

The frames tab 504 enables the user to view electronic picture frames coupled to (or in communication with) the system. FIG. 12 shows a GUI with various electronic picture frames under the frames tab 504, showing their serial numbers and statuses (e.g., paired or not paired). The user can disconnect (unpair) a given electronic picture frame from the system, and reconnect (pair) the given electronic picture frame to the system.

The GUI can include a counter telling the user how many media items (e.g., pictures) are in the slideshow and how much memory it is using.

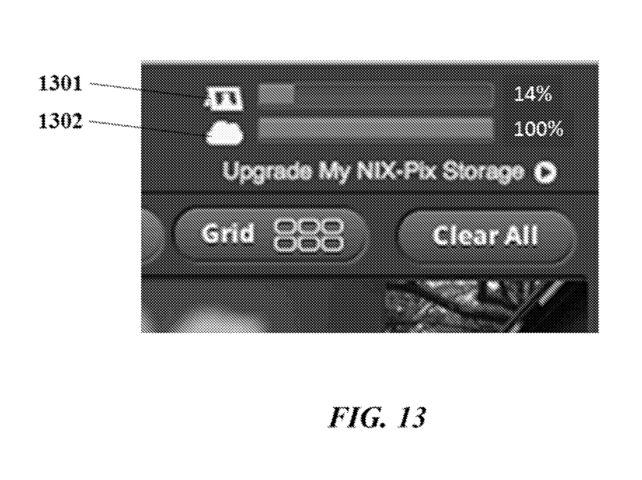

The GUI can further provide the user with information as to the amount of storage space remaining on a given electronic picture frame and the amount of storage space remaining on the system that is dedicated for use by the user. FIG. 13 shows a GUI with a first storage space indication 1301 and a second storage space indication 1302. The first storage space indication 1301 shows the degree to which the local storage (e.g., hard disk) of the use's electronic picture frame is occupied by media items. The second storage space indication 1302 shows the degree to which storage space on the system that is dedicated for use by the user is occupied by media items. Such dedicated storage space may be cloud storage space. In the illustrate example, the first storage space indication 1301 shows that the user's electronic picture frame is 14% full, and the second storage space indication 1302 shows that the user's dedicated system storage space is 100% full.

### Example 2

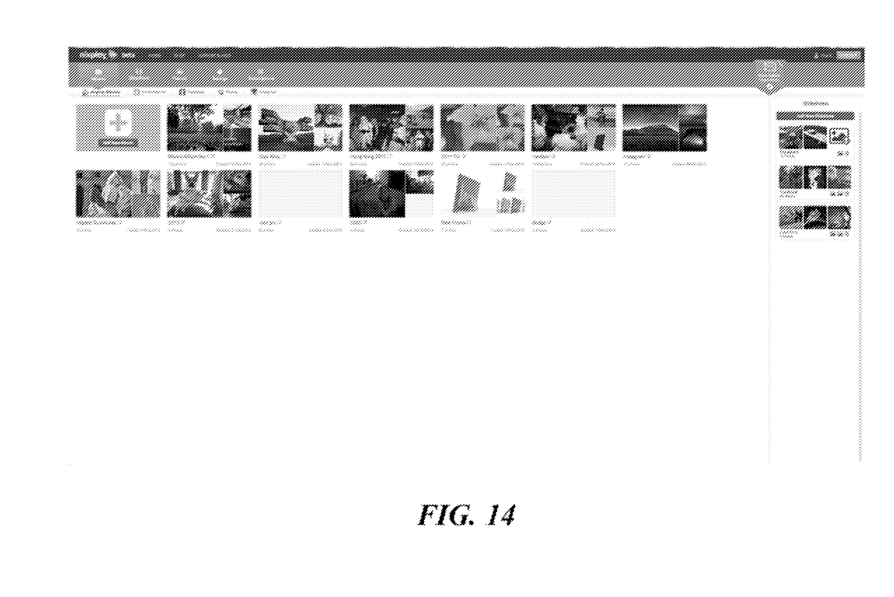

FIGS. 14-23 show screenshots of a graphical user interface (GUI) of a system that is programmed or otherwise configured to prepare media items (e.g., pictures) for broadcast on electronic picture frames.

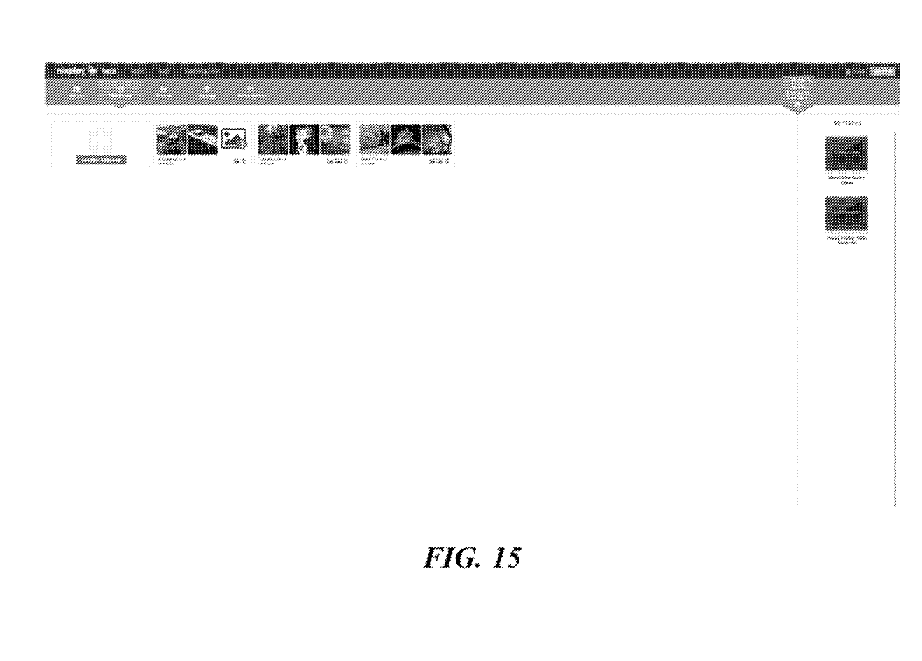

FIG. 14 is a screenshot of the GUI showing various albums. The albums can be generated by a user and can contain media items from various sources. FIG. 15 is a screenshot of the GUI showing various slideshows. The slideshows can be generated by a user and can contain media items that have been ordered to correspond to the order in which they are to be displayed on an electronic picture frame.

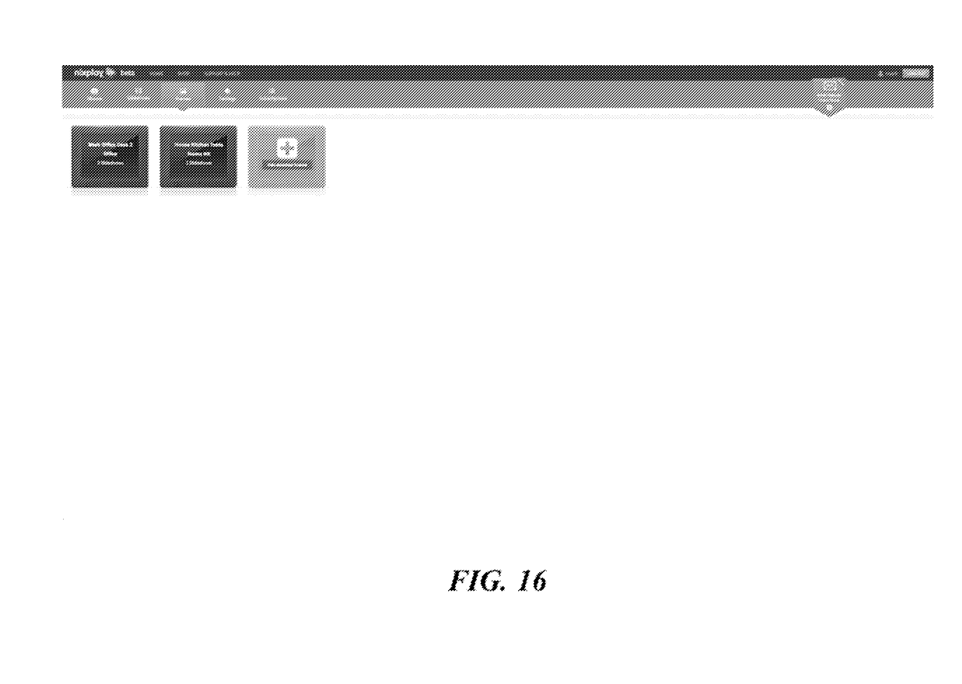

FIG. 16 is a screenshot of the GUI showing various electronic pictures frames that are available for use with the system. The user can elect to add additional electronic picture frames or to remove existing electronic pictures frame.

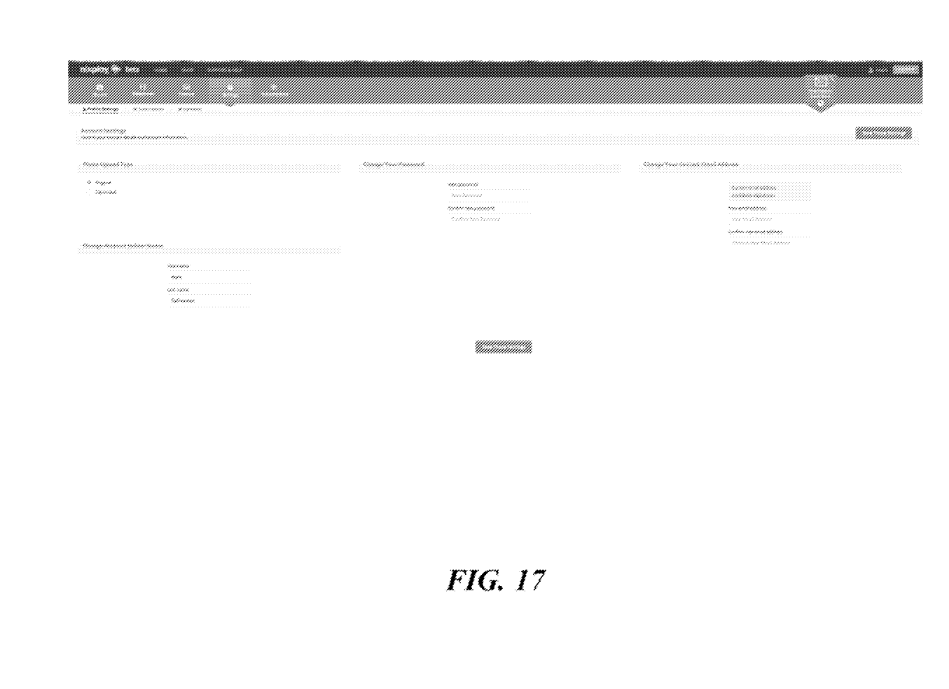

FIG. 17 is a screenshot of the GUI showing a settings page. The user can use the settings page to configure various features and functionalities of the system.

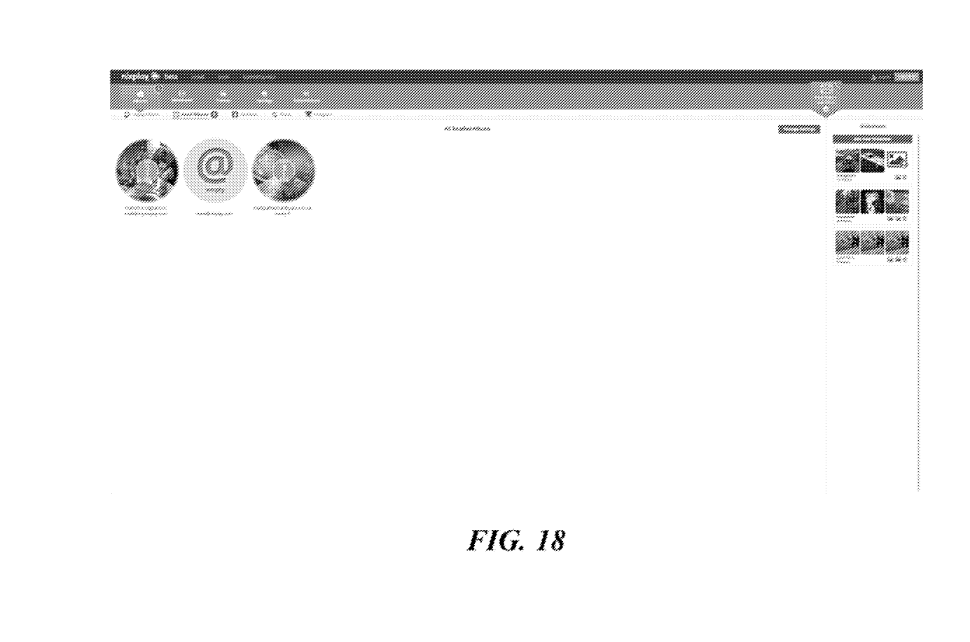

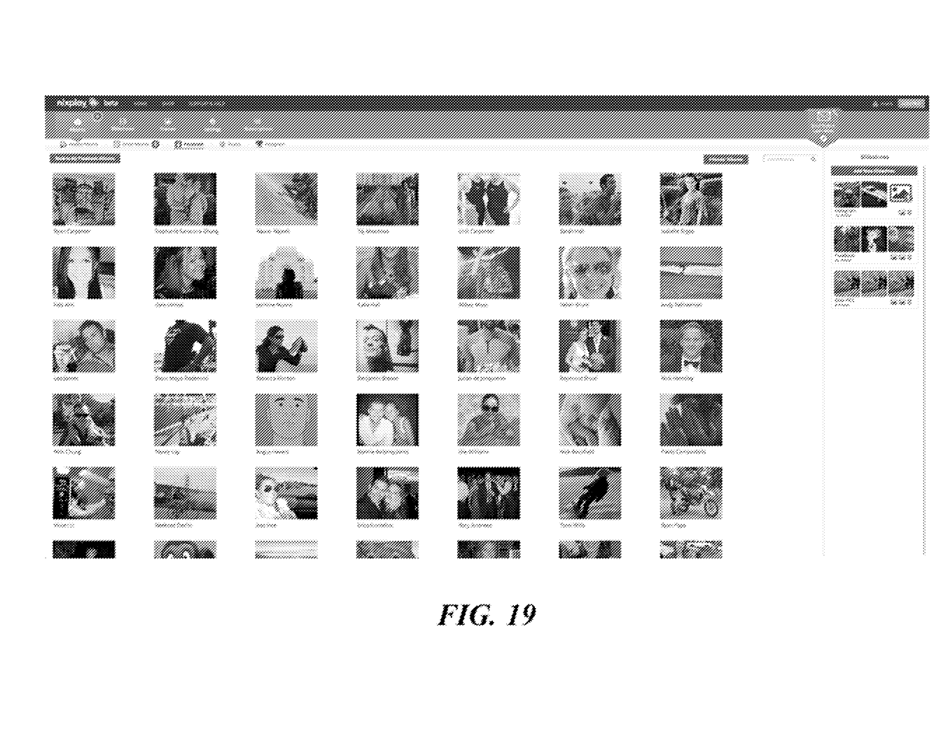

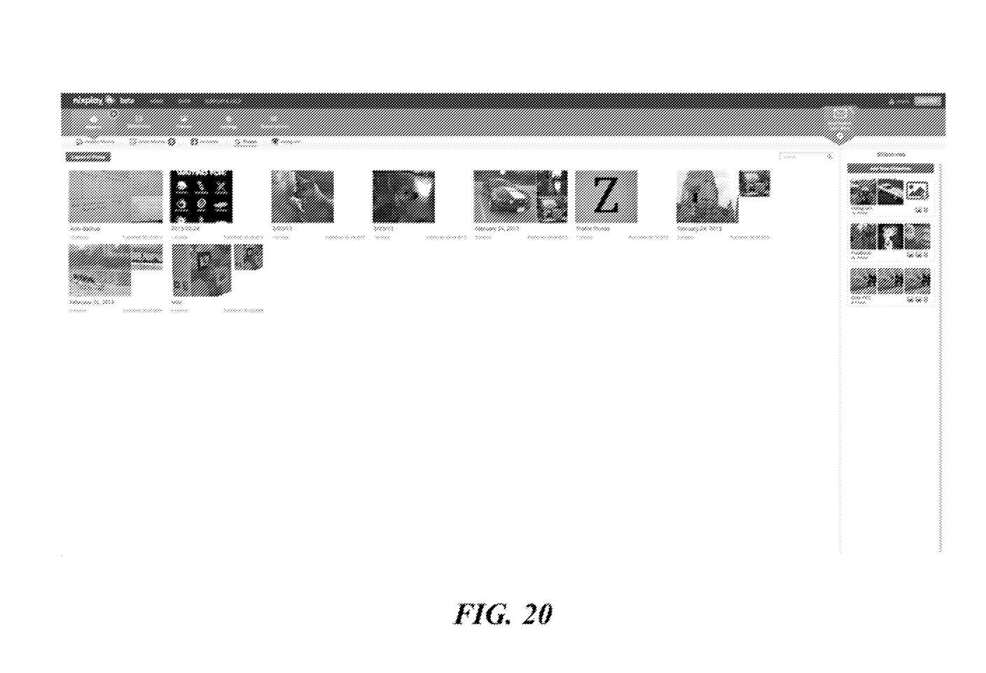

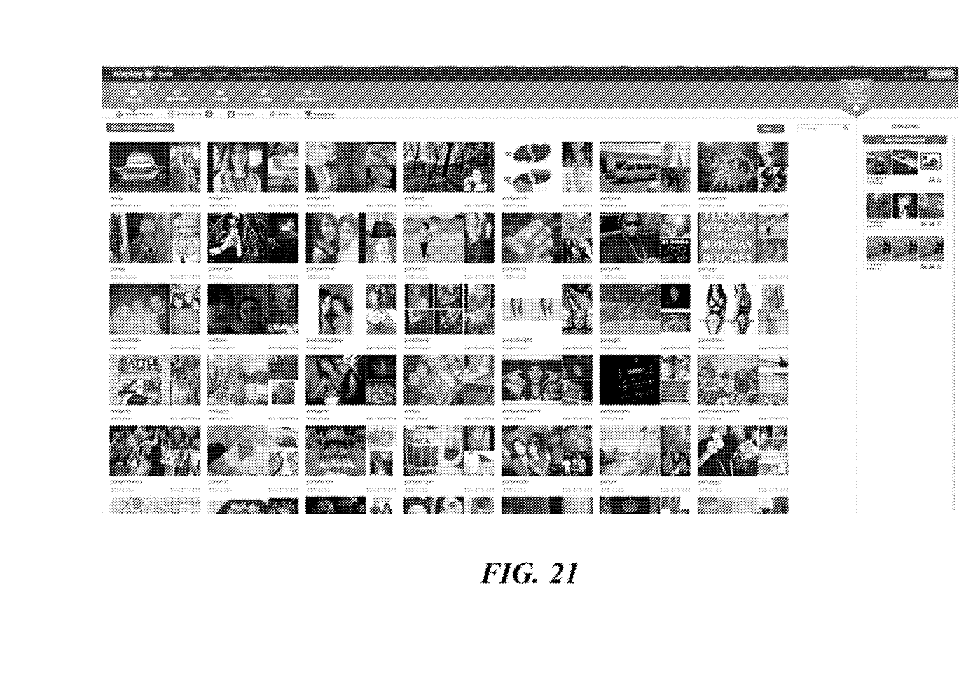

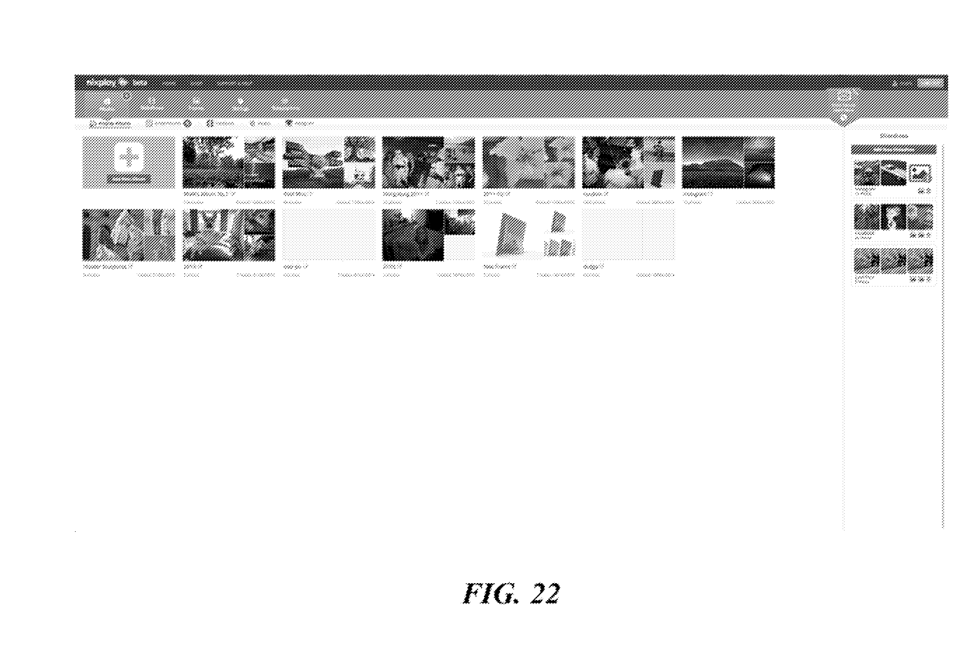

FIG. 18 is a screenshot of the GUI showing various albums. The albums can each be populated from various repositories, such as email and social networks (e.g., Facebook® or Instagram®). The screenshot shows email albums. Other albums can be selected, such as, for example, Facebook® albums (FIG. 19), Picasa® albums (FIG. 20) and Instagram® albums (FIG. 21). FIG. 22 is a screenshot of the GUI showing various albums generated by the user as well as albums that the user may have subscribed to (e.g., albums of other users).

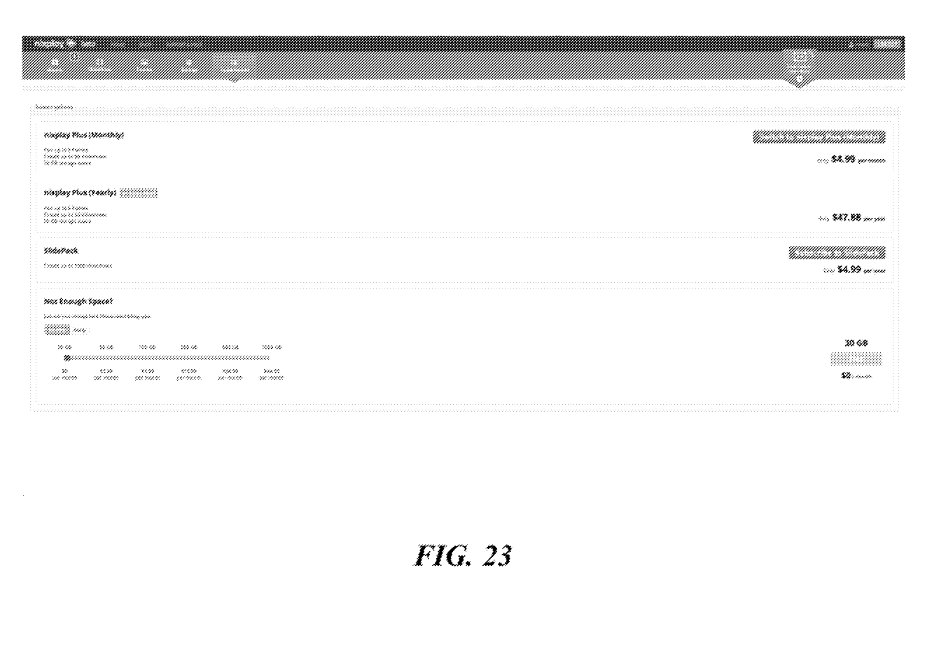

The system can permit a user to purchase storage space to store media items (e.g., pictures) and to regulate access to electronic picture frames. FIG. 23 is a screenshot of the GUI in which the user is provided the opportunity to purchase storage space and various plans.

Systems and methods of the present disclosure may be combined with and/or modified by other systems and methods, such as, for example, systems and/or methods described in U.S. Pat. No. 6,442,573 and U.S. Pat. No. 7,792,708, each of which is entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A computer-implemented method for displaying images, comprising:
(a) collecting, at a server programmed to collect images and generate slideshows from said images, a plurality images from one or more image repositories, wherein at least one image repository of said one or more image repositories is a network accessible image repository;
(b) generating, with the aid of a user interface on an electronic display coupled to said server, a slideshow comprising said plurality of images for display on an electronic picture frame;
(c) transmitting the slideshow to the electronic picture frame, wherein said electronic picture frame is located remotely with respect to the server; and
(d) displaying the slideshow on the electronic picture frame.

2. The method of claim 1, wherein said network accessible image repository comprises a social network web site.

3. The method of claim 1, wherein said network accessible image repository is accessible through a social network web site.

4. The method of claim 1, wherein said electronic display is part of a mobile electronic device.

5. The method of claim 1, wherein said slideshow show comprises an order of images that is selected by a user.

6. The method of claim 1, wherein said slideshow show comprises an order of images that is selected by said server.

7. The method of claim 1, wherein said slideshow show comprises an order of images that is selected by said electronic picture frame.

8. The method of claim 1, wherein said plurality of images is collected from a plurality of image repositories.

9. The method of claim 8, wherein said plurality of image repositories comprises a plurality of social network providers.

10. The method of claim 1, wherein said plurality of images is automatically collected by said server without any user involvement.

11. The method of claim 1, wherein said electronic picture frame is among a plurality of electronic picture frames that are in network communication with said server, and wherein each of said plurality of electronic picture frames is programmed to display said slideshow upon user request at said server.

12. The method of claim 1, wherein said user interface is a web interface.

13. The method of claim 1, wherein said plurality of images of said slideshow is from a first user, and wherein (d) comprises displaying said slideshow on said electronic picture frame that is of a second user.

14. A system for displaying images, comprising:
(a) a server programmed to (i) collect a plurality images from one or more image repositories, wherein at least one image repository of said one or more image repositories is a network accessible image repository, and (ii) generate a slideshow from at least a subset of said plurality of images;
(b) an electronic picture frame that is located remotely with respect to and in network communication with said server, wherein said electronic picture frame is programmed to (i) receive said slideshow from said server and (ii) display said slideshow.

15. The system of claim 14, wherein said network accessible image repository comprises a social network web site.

16. The system of claim 14, wherein said network accessible image repository is accessible through a social network web site.

17. The system of claim 14, wherein said slideshow show comprises an order of images that is selected by a user.

18. The system of claim 14, wherein said slideshow show comprises an order of images that is selected by said server.

19. The system of claim 14, wherein said slideshow show comprises an order of images that is selected by said electronic picture frame.

20. The system of claim 14, wherein said server is programmed to collect said plurality of images from a plurality of image repositories.

21. The system of claim 20, wherein said plurality of image repositories comprises a plurality of social network providers.

22. The system of claim 14, wherein said server is programmed to automatically collect said plurality of images without any user involvement.

23. A computer-readable medium comprising machine executable code that, upon execution by one or more computer processors, implements a method for displaying images, the method comprising:
(a) collecting, at a server programmed to collect images and generate slideshows from said images, a plurality images from one or more image repositories, wherein at least one image repository of said one or more image repositories is a network accessible image repository;
(b) generating, with the aid of a user interface on an electronic display coupled to said server, a slideshow comprising said plurality of images for display on an electronic picture frame;
(c) transmitting the slideshow to the electronic picture frame, wherein said electronic picture frame is located remotely with respect to the server; and
(d) displaying the slideshow on the electronic picture frame.
